(19) United States
(12) Patent Application Publication
(10) Pub. No.: US 2017/0371121 A1
(43) Pub. Date: Dec. 28, 2017

(54) BREAKOUT CANISTER FOR OPTICAL TRUNK CABLE

(71) Applicant: AFL TELECOMMUNICATIONS LLC, Duncan, SC (US)

(72) Inventors: Kyle Marchek, Greer, SC (US); Tom Sawyer, Greenville, SC (US)

(21) Appl. No.: 15/542,585

(22) PCT Filed: Jan. 26, 2016
(86) PCT No.: PCT/US16/14899

§ 371 Date: Jul. 10, 2017

Related U.S. Application Data
(60) Provisional application No. 62/107,901, filed on Jan. 26, 2015.
(60) Provisional application No. 62/127,606, filed on Mar. 3, 2015.
(60) Provisional application No. 62/213,956, filed on Sep. 3, 2015.

(51) Int. Cl. G02B 6/44

(52) U.S. Cl. CPC G02B 6/4472; G02B 6/4483

(57) ABSTRACT

An optical fiber trunk cable breakout canister comprising a main canister portion having a first smaller end and a second larger end. A stop is defined at a predetermined axial distance from the second larger end. A nozzle plate is received in the second larger end of the main canister portion and engages the stop, the nozzle plate carrying a plurality of axial nozzles. The distance between the nozzle plate and the second larger end of the main canister portion is greater than the axial length of the nozzles. In this embodiment, potting material is located in the main canister portion so as to cover and seal ends of the nozzles.

### BACKGROUND OF THE INVENTION

The present invention relates generally to fiber optic trunk cable. More particularly, the present invention relates to a breakout canister to facilitate breakout of individual data or power cables contained in an optical trunk cable.

The ability of high-quality optical fiber to transmit large amounts of information without appreciable signal degradation is well known. As a result, optical fibers have found widespread use in many applications, such as voice and data transmission. For example, optical fiber is often fed up a tower (or to a rooftop) to remote radio units (RRUs) located at the top. In this regard, FIGS. 1 and 2 illustrate a hybrid power/data trunk cable that can be used for this purpose. As shown, the trunk cable is fed in this example from a baseband unit (BBU) to multiple RRUs located, e.g., on top of a tower. A breakout canister located near the top of tower is used to separate the power or fiber conductors needed for each of the RRUs.

Different styles of breakout canisters are known. In this regard, FIGS. 3 and 4 respectively illustrate a two-piece screw canister and a three-piece c-clip canister. The two-piece screw canister design uses a heat shrink material to seal protruding cable from the nozzle area. Entry of water into the canister is an issue if the heat shrink is not sealed properly around the nozzle and cable jacket. In addition, the heat shrink material is relatively expensive, raising overall costs. FIG. 5 shows an example of an assembled two-piece screw canister with heat shrink and cable.

An example of the three-piece c-clip canister design is shown in FIGS. 6 and 7. In this case, corrugated tubes are placed over the cables and nozzles and sealed with epoxy. (This particular application requires corrugated tubes over the fiber cables for protection against birds.) The area where the fiber cable exits the nozzle is sealed with epoxy (for sealing against entry of water) before the corrugated tube is placed over this area. The bottom location where the main trunk cable enters the canister is sealed with heat shrink, as shown in FIG. 8.

The present invention recognizes the foregoing considerations, and others, of the prior art.

### SUMMARY OF THE INVENTION

According to one aspect, the present invention provides an optical fiber trunk cable breakout canister comprising a main canister portion have a first smaller end and a second larger end, a stop being defined at a predetermined axial distance from the second larger end. A nozzle plate carrying a plurality of axial nozzles is received in the second larger end of the main canister portion such that it engages the stop. A first axial distance between the nozzle plate and ends of the nozzles is lass than a second axial distance between the nozzle plate and the second larger end of the main canister portion. Potting material (e.g., epoxy and/or urethane) is located in the main canister portion so as to cover and seal the nozzle ends.

In some embodiments, a cushioning element (e.g., an O-ring gasket) may interpose the stop and nozzle plate such that the nozzle plate engages the stop through the cushioning element. Moreover, the main canister portion may define a groove on an inner surface thereof spaced apart from the stop, the groove receiving a retaining clip such that the nozzle plate is located between the stop and the retaining clip.

The main canister portion may be integrally formed having a smaller first tubular portion at which the first smaller end is located, an intermediate conical portion, and a larger second tubular portion at which the second larger end is located. The first smaller end may define a recessed shoulder in which potting material is received.

Preferably, the potting material fills an area in the main canister portion having a third axial distance greater than the second axial distance. In many cases, the third axial distance may be less than the second axial distance.

Another aspect of the present invention provides an arrangement comprising a breakout canister having a main canister portion with a first end and a second end and a nozzle plate located in the main canister portion. The nozzle plate carries a plurality of nozzles oriented toward the second end of the main canister portion. In this case, the main housing portion and the nozzle plate are configured such that the nozzles are located entirely inside an axial length of the main canister portion. An optical trunk cable having a plurality of subunits contained in an outer jacket is broken out inside of the breakout canister such that the subunits pass through the nozzles. Potting material is located in the main canister portion so as to cover and seal ends of the nozzles.

A further aspect of the present invention provides a method of breaking out an optical trunk cable. One step of the method involves providing a breakout canister comprising a main canister portion having a first smaller end and a second larger end, the breakout canister further having a separate nozzle plate carrying a plurality of axial nozzles. According to another step, a portion of an outer jacket of the trunk cable is removed so that subunits in the trunk cable can be separated. The trunk cable is passed through the first smaller end of the main canister portion such that the first smaller end surrounds the outer jacket but the subunits are separate inside the main canister portion. According to another step, the nozzle plate is positioned in the main canister portion such that the nozzles are located entirely inside an axial length of the main canister portion, the subunits passing through the nozzles out the second larger end of the main canister portion. An area inside of the main canister portion between the nozzle plate and the second larger end is filled with a potting material that covers and thus seals ends of the nozzles.

Other objects, features and aspects of the present invention are provided by various combinations and subcombinations of the disclosed elements, as well as methods of practicing same, which are discussed in greater detail below.

### BRIEF DESCRIPTION OF THE DRAWINGS

A full and enabling disclosure of the present invention, including the best mode thereof, to one of ordinary skill in the art, is set forth more particularly in the remainder of the specification, including reference to the accompanying drawings, in which:

FIG. 1 is a diagrammatic representation showing a trunk cable being broken out into three RRUs using a direct breakout canister of the prior art.

FIG. 2 is a diagrammatic representation showing more detail regarding the trunk cable used in FIG. 1.

FIG. 3 shows a two-piece screw canister of the prior art with parts separated.

FIG. 4 shows a three-piece C-clip canister of the prior art with parts separated.

FIG. 5 shows use of heat shrink tubing with the nozzles of the canister of FIG. 3.

FIGS. 6-8 show additional detail regarding the use of the canister of FIG. 4.

FIG. 9 is an exploded view of an improved canister in accordance with the present invention.

FIG. 10 is a partial cross-sectional view of the canister of FIG. 9 with parts assembled.

FIG. 11 is a view similar to FIG. 10 as it would appear in use to break out a trunk cable.

FIGS. 12-14 are similar to FIGS. 9-11, respectively, but show the addition of an optional annular cushioning element between the nozzle plate and the main canister.

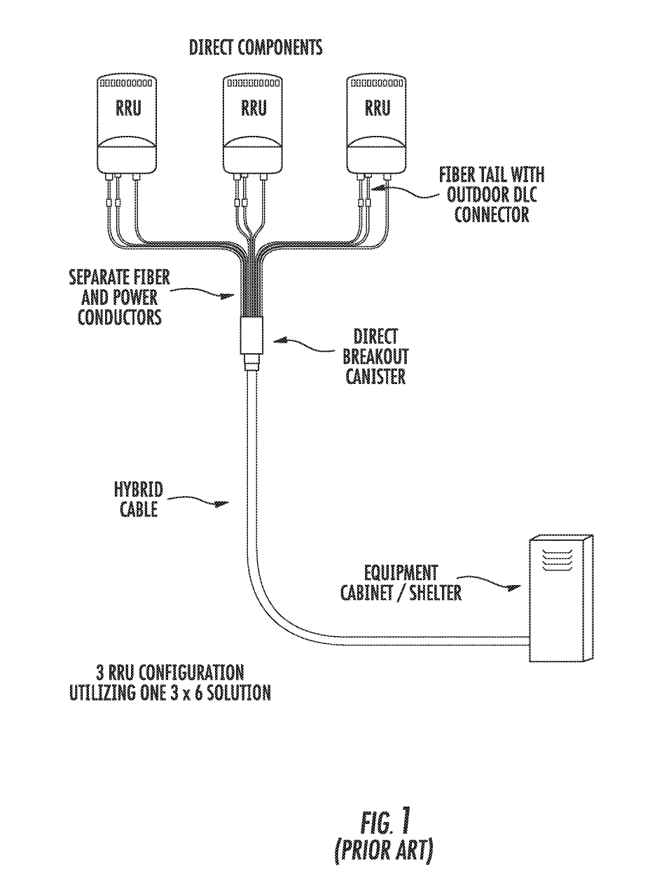

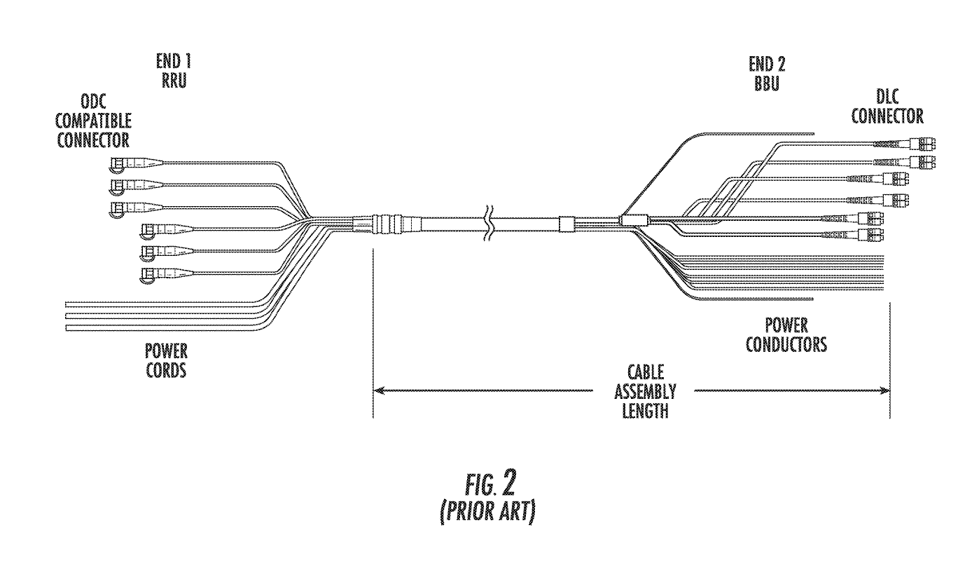

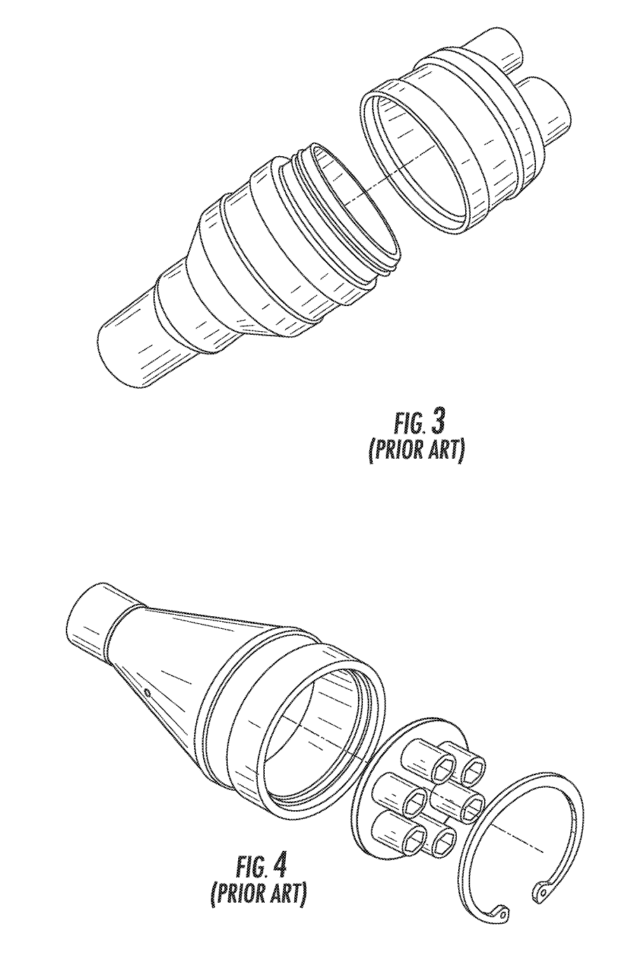

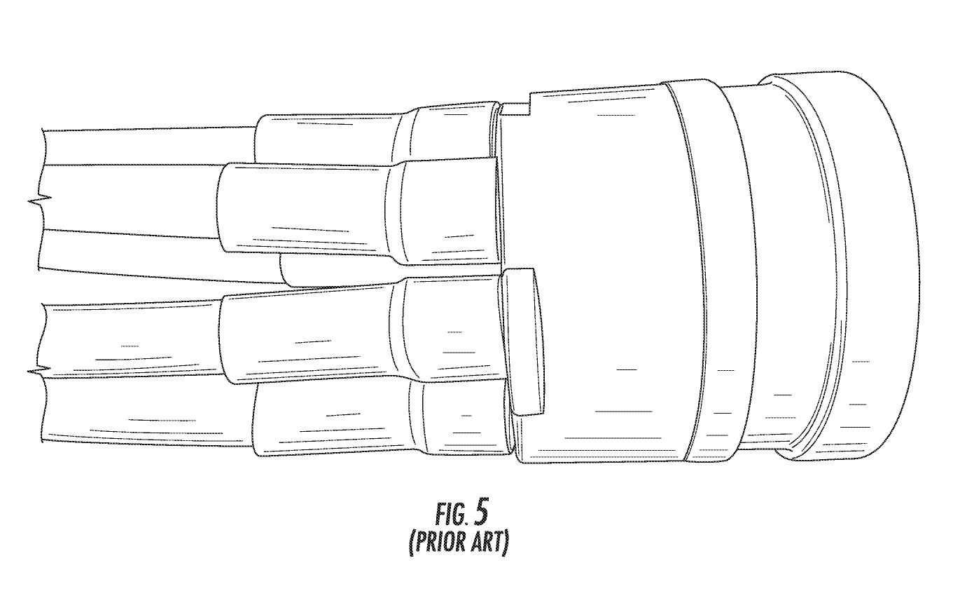

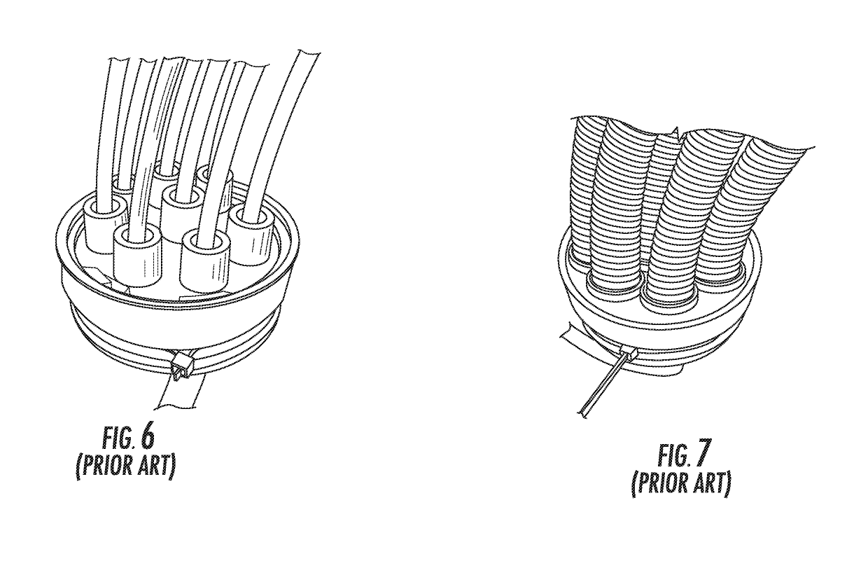

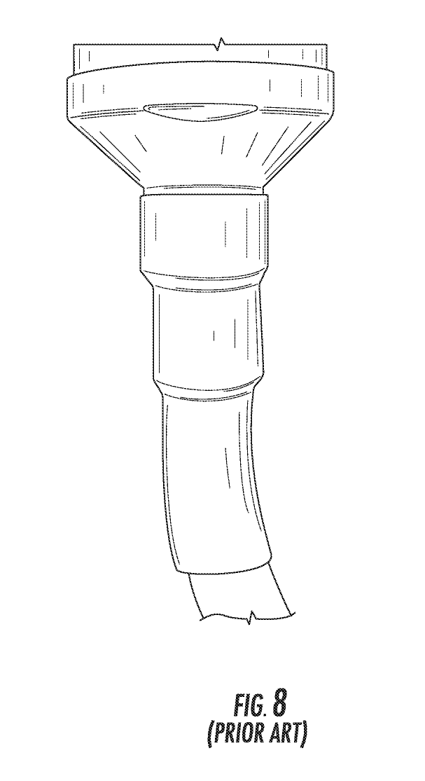

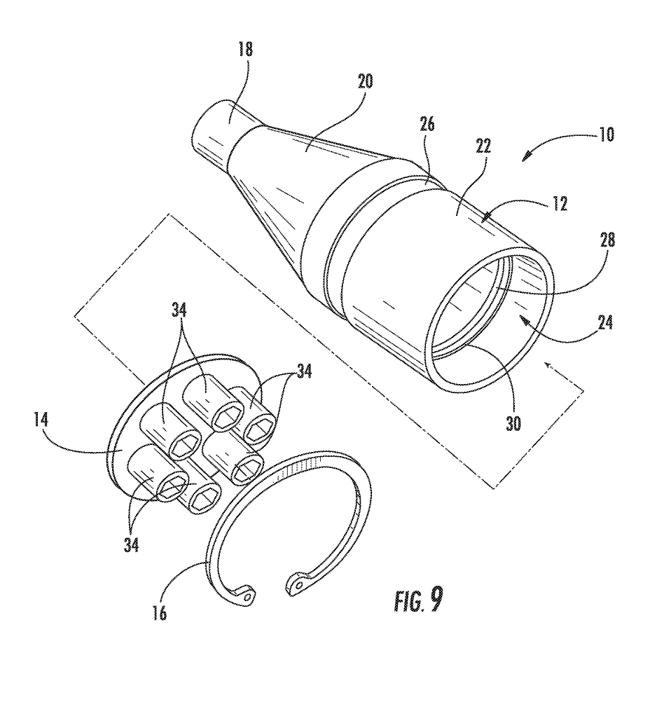

Repeat use of reference characters in the present specification and drawings is intended to represent same or analogous features or elements of the invention.

### DETAILED DESCRIPTION OF PREFERRED EMBODIMENTS

It is to be understood by one of ordinary skill in the art that the present discussion is a description of exemplary embodiments only, and is not intended as limiting the broader aspects of the present invention, which broader aspects are embodied in the exemplary constructions.

Referring now to FIGS. 9-11, the present invention provides an improved breakout canister which overcomes various considerations of the prior art. In this embodiment, a breakout canister 10 comprises a main canister 12, a nozzle plate 14, and a C-clip 16. Main canister 12 has a hollow interior in which individual cables of the trunk cable are separated. In this regard, the main trunk cable enters an opening at a smaller end 18. A conical portion 20 increases the diameter of main canister 12 to that of a larger cylindrical portion 22. Portion 22 defines an open end 24 into which nozzle plate 14 is received. One or more grooves, such as groove 26, may circumscribe the outer surface of main canister 12 for attachment of mounting clamps and the like.

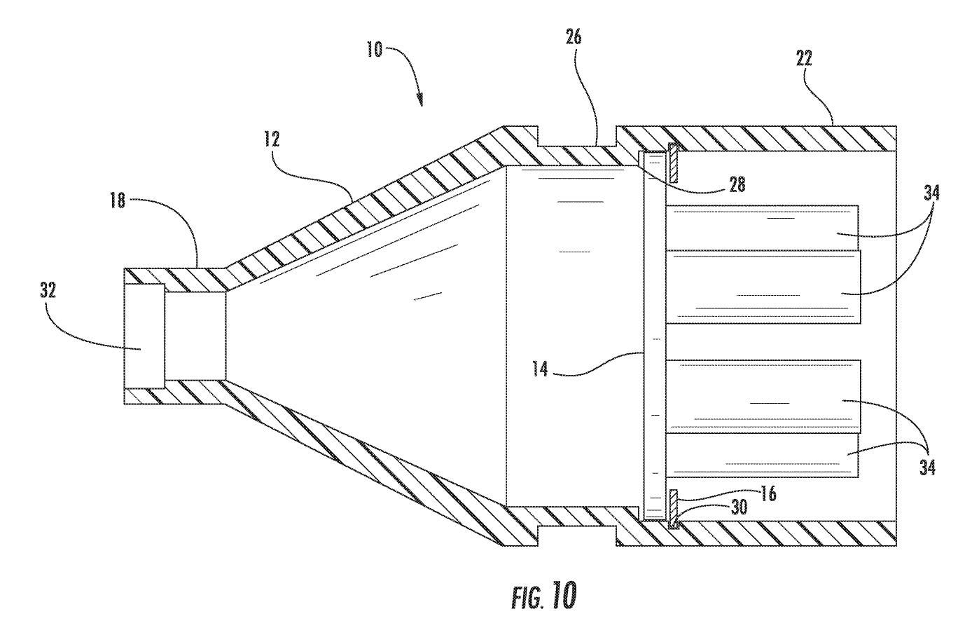

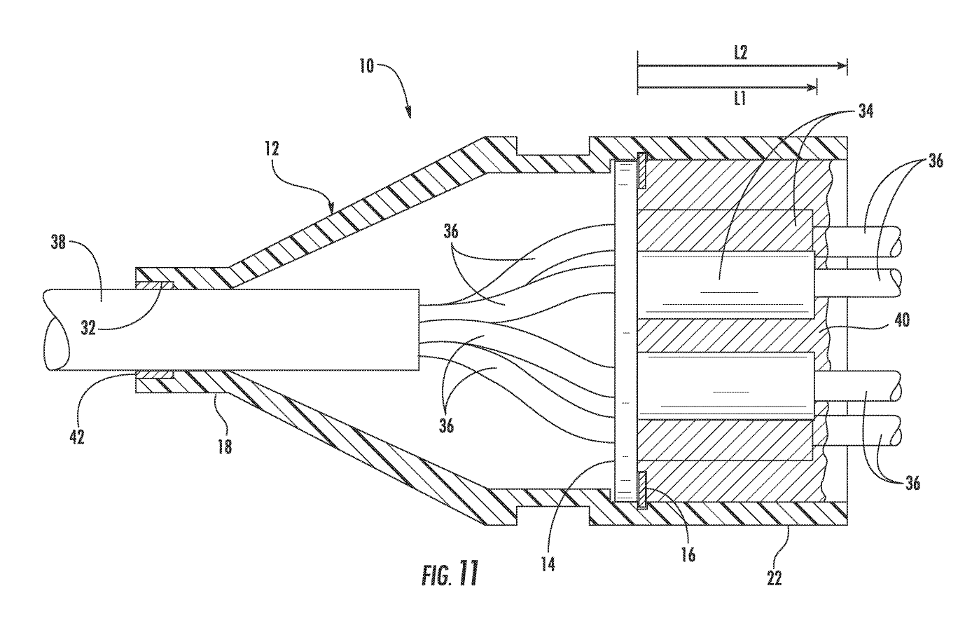

As can be most easily seen in FIG. 10, the interior of portion 22 preferably defines a stop 28 which will prevent further insertion of nozzle plate 14. In other words, nozzle plate 14 is inserted until it is reaches stop 28. C-clip 16 is then radially compressed and inserted into opening 24 behind nozzle plate 14. When C-clip 16 reaches a radial groove 30, it expands so as to lock nozzle plate 14 into place. As shown, groove 30 is spaced apart from stop 28 by an axial distance slightly greater than the width of nozzle plate 14. Smaller end 18 of main canister 12 preferably defines an interior shoulder 32 for reasons that will be described below.

Nozzle plate 14 carries a plurality of cylindrical nozzles 34 through which subunits of separated cables can be routed. This is shown in FIG. 11, where subunits 36 of trunk cable 38 are shown separated inside of canister 10 and pass through separate nozzles 34. As can be seen, nozzles 34 preferably have an axial length L1 which is less than the axial length L2 between nozzle plate 14 and the end of portion 22. As a result, the protruding cable from the nozzles can be potted and sealed with epoxy, urethane, or other suitable potting material, as shown at 40. Because the potting material covers the ends of nozzles 34, no heat shrink is required to seal these areas. While the potting material is not flush with the end of portion 22 in this example, one skilled in the art will recognize that flush potting may be desirable in some applications.

The opening through which trunk cable 38 is received may also be sealed without use of heat shrink material in this embodiment. Specifically, as indicated at 42, epoxy or other suitable potting material may be located in shoulder 32 to effectively seal this interface.

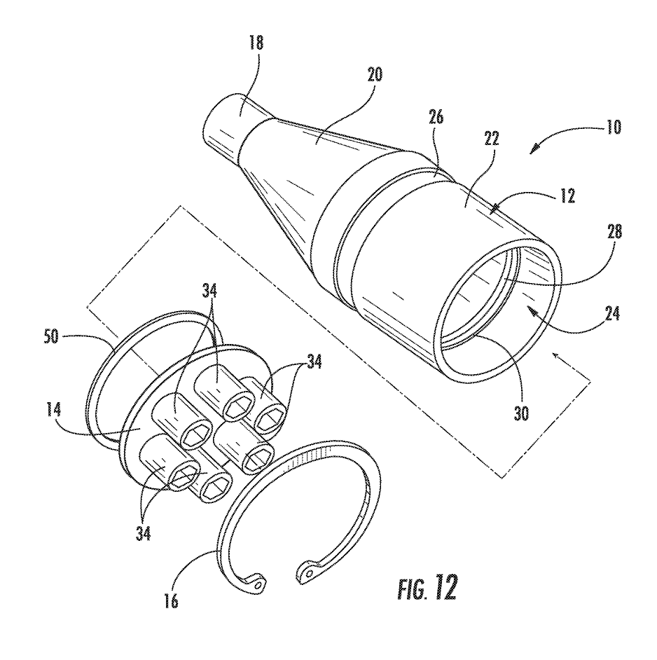

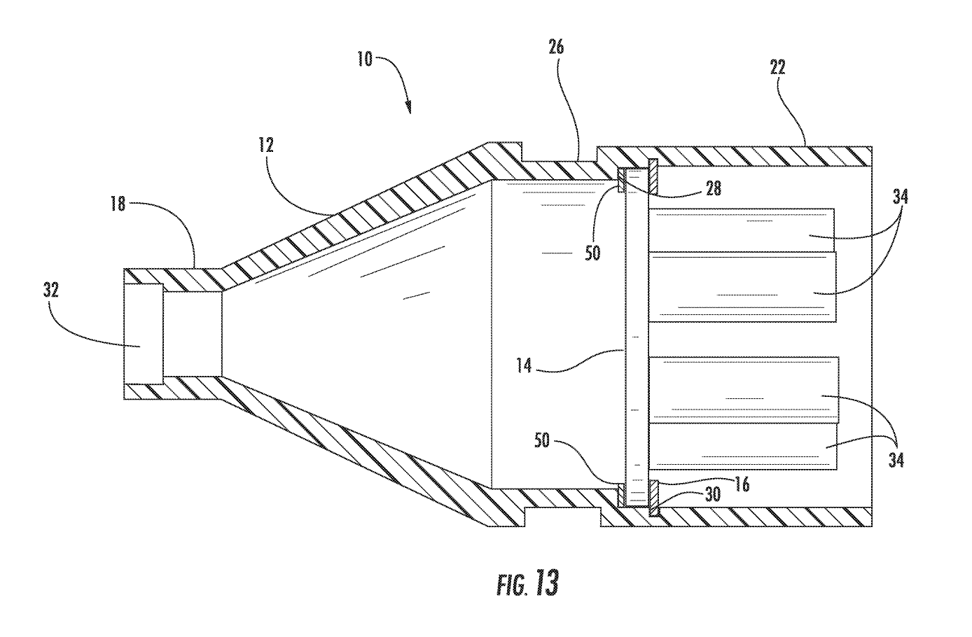

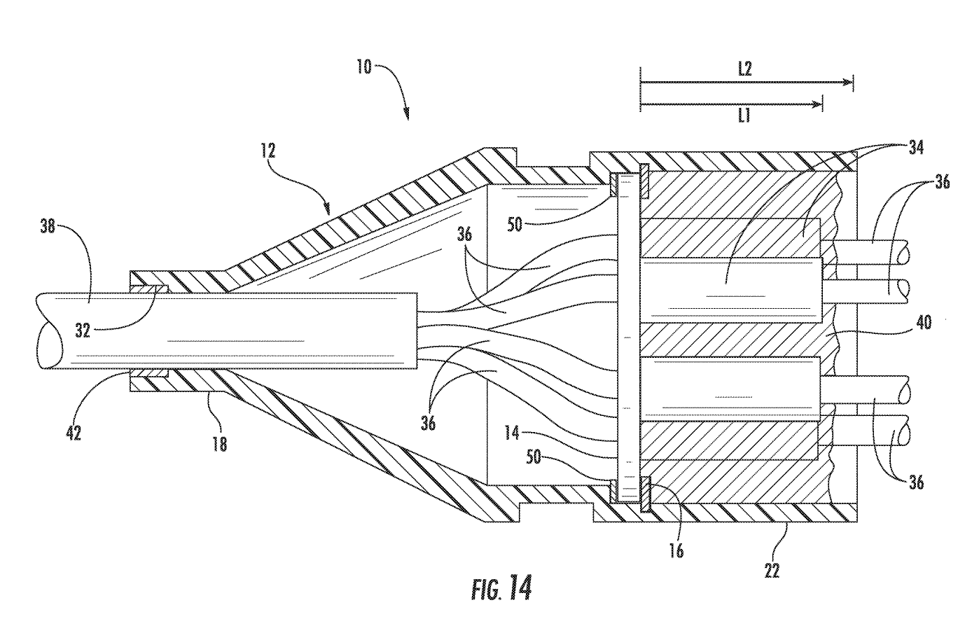

Referring now to FIGS. 12-14, an alternative embodiment is illustrated. In this case, an optional annular cushioning element 50 is provided between nozzle plate 14 and main canister 12. For example, the cushioning element 50 may be any suitable gasket, or solid or hollow O-ring, formed of an appropriate resilient material. In this embodiment, element 50 is captured between the back face of nozzle plate 14 and stop 28 when the components are assembled. As shown in FIGS. 13-14, element 50 preferably compresses as nozzle plate 14 is moved into position and retained via C-clip 16.

Alternatively, embodiments are contemplated in which plate 14 is retained by potting material, such as potting material 40 of FIG. 11, without the use of a C-clip 16. Moreover, embodiments are contemplated in which stop 28 is provided by a C-clip or the like on the portion 22 side of the plate 14. Furthermore, stop 28 may be omitted in some embodiments, such as embodiments that utilize potting material 40.

It can thus be seen that the present invention provides an improved fiber cable breakout canister. While preferred embodiments of the invention have been shown and described, modifications and variations may be made thereto by those of ordinary skill in the art without departing from the spirit and scope of the present invention. Furthermore, it should be understood that aspects of the various embodiments may be interchanged both in whole or in part. Furthermore, those of ordinary skill in the art will appreciate that the foregoing description is by way of example only, and is not intended to be limitative of the invention as further described in the appended claims.

What is claimed is:

1. An optical fiber trunk cable breakout canister comprising:
a main canister portion have a first smaller end and a second larger end, a stop being defined at a predetermined axial distance from said second larger end;
a nozzle plate received in said second larger end of said main canister portion and engaging said stop, said nozzle plate carrying a plurality of axial nozzles;
a first axial distance between said nozzle plate and ends of said nozzles being lass than a second axial distance between said nozzle plate and said second larger end of said main canister portion; and
potting material located in said main canister portion so as to cover and seal said ends of said nozzles.

2. An optical fiber trunk cable breakout canister as set forth in claim 1, comprising a cushioning element interposing said stop and said nozzle plate such that said nozzle plate engages said stop through said cushioning element.

3. An optical trunk cable breakout canister as set forth in claim 2, wherein said cushioning element comprises an O-ring gasket.

4. An optical trunk cable breakout canister as set forth in claim 1, wherein said main canister portion defines a groove on an inner surface thereof spaced apart from said stop, said groove receiving a retaining clip such that said nozzle plate is located between said stop and said retaining clip.

5. An optical trunk cable breakout canister as set forth in claim 4, wherein said potting material is selected from a group consisting of epoxy and urethane.

6. An optical trunk cable breakout canister as set forth in claim 1, wherein said main canister portion is integrally formed having a smaller first tubular portion at which said first smaller end is located, an intermediate conical portion, and a larger second tubular portion at which said second larger end is located.

7. An optical trunk cable breakout canister as set forth in claim 6, wherein said first smaller end defines a recessed shoulder in which potting material is received.

8. An optical trunk cable breakout canister as set forth in claim 1, wherein said potting material fills an area in said main canister portion having a third axial distance greater than said second axial distance.

9. An optical trunk cable breakout canister as set forth in claim 1, wherein the third axial distance is less than the second axial distance.

10. An arrangement comprising:
a breakout canister having a main canister portion with a first end and a second end and a nozzle plate located in said main canister portion, said nozzle plate carrying a plurality of nozzles oriented toward said second end of said main canister portion;
said main housing portion and said nozzle plate being configured such that said nozzles are located entirely inside an axial length of said main canister portion; and
an optical trunk cable having a plurality of subunits contained in an outer jacket, said trunk cable broken out inside of said breakout canister such that said subunits pass through said nozzles; and
potting material located in said main canister portion so as to cover and seal ends of said nozzles.

11. An arrangement as set forth in claim 10, wherein said main canister portion defines a stop engaged by said nozzle plate.

12. An arrangement as set forth in claim 11, comprising a cushioning element interposing said stop and said nozzle plate such that said nozzle plate engages said stop through said cushioning element.

13. An arrangement as set forth in claim 11, wherein said main canister portion defines a groove on an inner surface thereof spaced apart from said stop, said groove receiving a retaining clip such that said nozzle plate is located between said stop and said retaining clip.

14. An arrangement as set forth in claim 10, wherein said potting material is selected from a group consisting of epoxy and urethane.

15. An arrangement as set forth in claim 10, wherein said main canister portion is integrally formed having a smaller first tubular portion at which a first smaller end is located, an intermediate conical portion, and a larger second tubular portion at which a second larger end is located.

16. An arrangement as set forth in claim 15, wherein said first smaller end defines a recessed shoulder in which potting material is received.

17. A method of breaking out an optical trunk cable comprising steps of:
(a) providing a breakout canister comprising a main canister portion having a first smaller end and a second larger end, said breakout canister further having a separate nozzle plate carrying a plurality of axial nozzles;
(b) removing a portion of an outer jacket of said trunk cable so that subunits in said trunk cable can be separated;
(c) passing said trunk cable through said first smaller end of said main canister portion such that said first smaller end surrounds said outer jacket but said subunits are separate inside said main canister portion;
(d) positioning said nozzle plate in said main canister portion such that said nozzles are located entirely inside an axial length of said main canister portion, said subunits passing through said nozzles out said second larger end of said main canister portion; and
(e) filling an area inside of said main canister portion between said nozzle plate and said second larger end with a potting material that covers and thus seals ends of said nozzles.
